(19) United States
(12) Patent Application Publication
(10) Pub. No.: US 2008/0092070 A1
(43) Pub. Date: Apr. 17, 2008

(54) SYSTEMS AND METHODS FOR PRESENTATION OF OPERATIONAL DATA

(75) Inventors: Terry Unsworth, Chico, CA (US); Mark Hernandez, Chico, CA (US); Brock Peterson, Oroville, CA (US)

Correspondence Address: BLACK LOWE & GRAHAM, PLLC, 701 FIFTH AVENUE, SUITE 4800, SEATTLE, WA, 98104, US

(73) Assignee: LAKE UNION CAPITAL PARTNERS, LLC, Seattle, WA (US)

(21) Appl. No.: 11/549,896

(22) Filed: Oct. 16, 2006

(51) Int. Cl. G06F 3/048

(52) U.S. Cl. 715/764

(57) ABSTRACT

Methods and apparatus for presenting event activities associated with an operational system having sensors. The apparatus includes a display device and a processing device in data communication with the display device. The processing device detects events that exceed a predefined threshold limit based on data produced by the sensors. The processing device also determines the location of the detected events and presents a 3-dimensional model of the system and activity icons on the display device based on the identified location. Each activity icon is associated with a detected event. The activity icons vary in color, shape, or size based on a detected intensity for the event. Parts of the system that are affected by an event are identified if the components of the 3-dimensional model that are associated with the parts intersect with at least one of the presented activity icons. The operational system is a vehicle or manufacturing machinery.

### BACKGROUND OF THE INVENTION

Many software application programs have been developed in order to allow maintenance and operational personnel to analyze recorded data of mechanical systems, such as vehicles, factory machinery or other equipment that incur stresses and strains during operation. An example software application program is FlightAnalyst™ produced by SimAuthor. The FlightAnalyst™ application program receives flight data as recorded by an aircraft. The recorded flight data includes various information, such as position of flight control surfaces, engine settings, and data supplied by stress or strain sensors positioned throughout the aircraft, and any other data recording device that might be used for analyzing the flight or the condition of the aircraft. FlightAnalyst™ processes the received data and produces various presentations that allow for analysis of the received data. For example, as shown in FIG. 1, various types of performance charts and statistical analysis graphs are presented for a user to view and analyze. Also, a visualization or flight re-enactment component allows a user to see actual aircraft position and control surface movement that occurred throughout a flight. FlightAnalyst™ also produces an event detection component that identifies when specialized events have occurred throughout the flight of the aircraft. For example, an event that might be detected would be one where a stress or strain on a wing spar has exceeded a threshold limit. The event detection component would show this in a chart or may produce a graph that might further define or show the occurrence of the detected event.

The FlightAnalyst™ application program is an adequate tool for presenting various types of information recorded about the aircraft and for showing anomaly events that may have occurred. However, if an anomaly event has occurred, it is difficult for a user to easily determine exactly where this event has taken place on the aircraft. In order for a user to determine exact location of a detected event, the user would need a separate graphical chart of an aircraft that shows joint or spar locations that might be used to identify a specific location for the detected event.

Therefore, there exists a need for a graphical user interface that easily presents to a user exact locations of anomaly events that have occurred and have been detected through analysis of data recorded about a system.

### BRIEF SUMMARY OF THE INVENTION

The present invention provides methods and apparatus for presenting event activities associated with an operational system having sensors. The apparatus includes a display device and a processing device in data communication with the display device. The processing device detects events that exceed a predefined threshold limit based on data produced by the sensors. The processing device also determines the location of the detected events and presents a 3-dimensional model of the system and activity icons on the display device based on the identified location. Each activity icon is associated with a detected event.

In one aspect of the invention, the activity icons vary in color, shape, or size based on a detected intensity for the event.

In another aspect of the invention, a time of occurrence is associated with each detected event. Also, a video image of the system is generated and presented with the detected events based on the identified time of occurrence.

In still another aspect of the invention, parts of the system that are affected by an event are identified if components of the 3-dimensional model that is associated with the parts intersect with at least one of the presented activity icons.

In still yet another aspect of the invention, the operational system is a vehicle or manufacturing machinery.

### BRIEF DESCRIPTION OF THE SEVERAL VIEWS OF THE DRAWING

The preferred and alternative embodiments of the present invention are described in detail below with reference to the following drawings.

FIG. 1 illustrates a screenshot of an existing graphical user interface;

FIG. 2 illustrates a computer system for executing a graphical user interface formed in accordance with an embodiment of the present invention;

FIG. 3 illustrates a flow diagram of an example process performed by the computer system shown in FIG. 2; and

FIGS. 4-6 are screenshots of a graphical user interface presented by the computer system of FIG. 2 in accordance with an embodiment of the present invention.

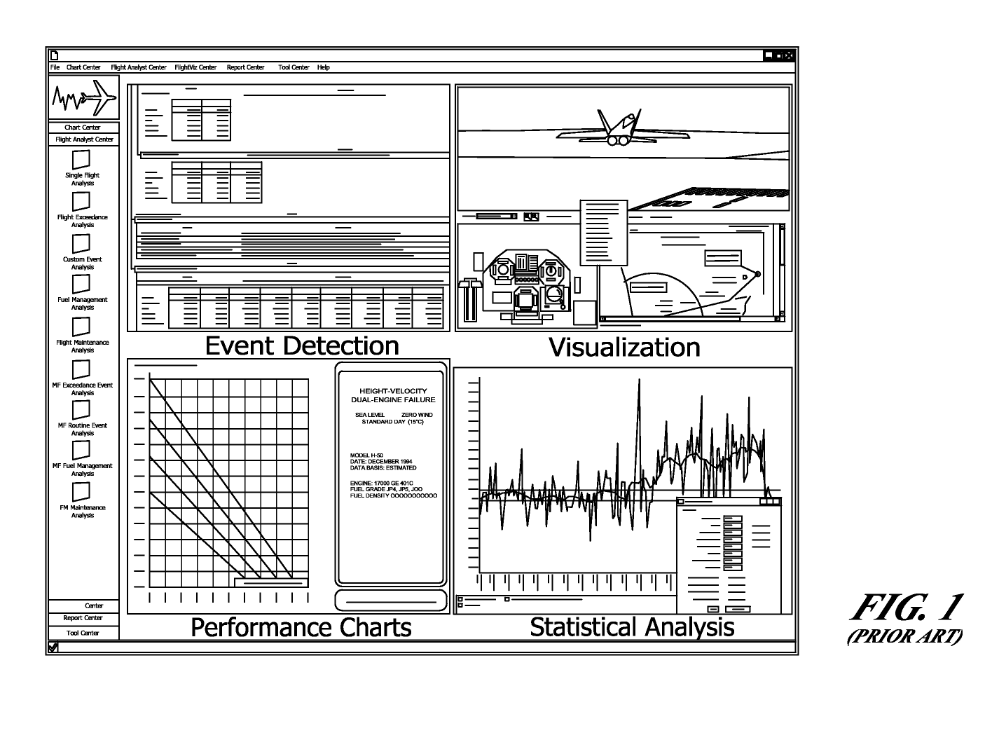

### DETAILED DESCRIPTION OF THE INVENTION

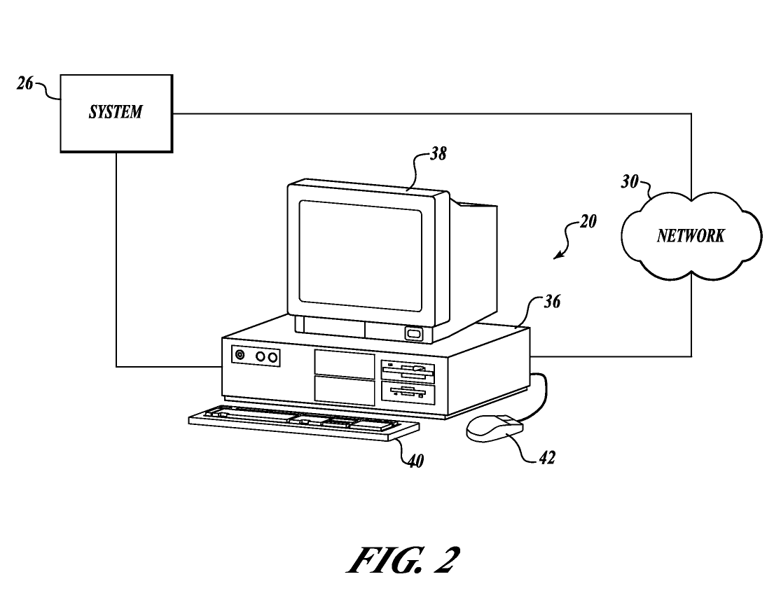

As shown in FIG. 2, a system 20 performs analysis and presentation of operational and sensor data of an observed operational system 26. The system 20 is suitably an off-the-shelf computer system that includes a processing device 36 with associated permanent and temporary data storage components, a display device 38, and a user interface, such as a keyboard 40, and a mouse 42. The processor 36 received operational and/or sensor data from the observed system 26 either through a direct connection, a connection over a network 30, or via some type of removable storage device. The processing device 36 then processes the received data for presentation in a graphical user interface on the display 38.

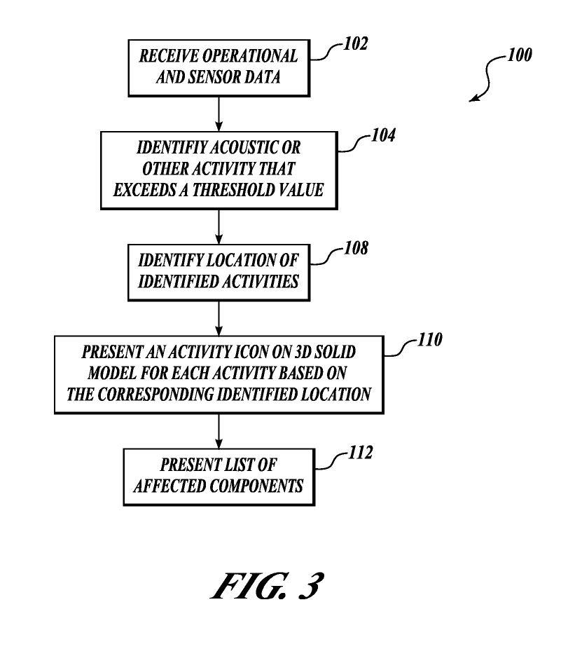

FIG. 3 illustrates a flow diagram of an example process 100 performed by the system 20 shown in FIG. 2. First, at a block 102, the system 20 receives operational or sensor data of the observed system 26. At a block 104, the processor 36 analyzes the received data to identify if any event, such as a stress or strain activity or operational events like speed, G-force, altitude, flap position, etc., has occurred that exceeds a predefined threshold value. At a block 108, the processor 36 identifies a location associated with the identified event. At a block 110, a three-dimensional (3D) model of the system 26 or a portion of the system 26, such as a 3D solid model, is presented on the display 38. The processor 36 also presents one or more event (activity) icons with the 3D model for each identified event based on the identified location for the activity as it relates to a location relative to the 3D model. At a block 112, the processor 36 generates a list of components within the 3D model that intersect or interact with the activity icon. Two-dimensional models may be used.

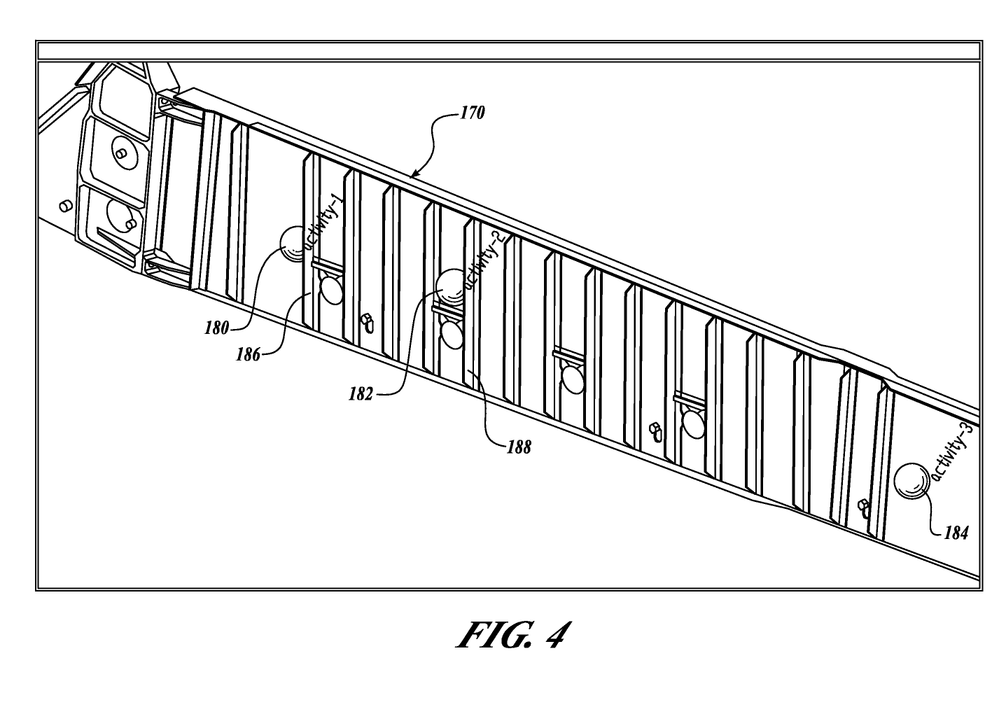

FIG. 4 illustrates an example partial view of a 3D model that has been presented on the display 38. In this example, the presented model is a cross-sectional view of an aircraft wing spar 3D model 170. In this example, three activity icons are presented at various locations throughout the model 170. A first activity icon 180 is positioned adjacent to a first vertical support beam 186. A second activity icon 182 is positioned adjacent to a second vertical support beam 188, and a third activity icon 184 is located near an end of the model 170. In one embodiment, the activity icons 180, 182, and 184 are generated based upon detection of an event at those locations.

In one embodiment, the activity icons 180-184 are spherical and are sized to a predefined radius. However, the activity icons may be of various sizes or shapes depending upon user preferences. Also, the activity icons may be displayed in different colors depending upon intensity of the detected event. For example, activity icons 180 and 184 are presented in red and the second activity icon 182 is presented in amber. The red indicates a more intense event occurred at that location. In one embodiment, the location of the sphere is determined by a processing method separate from that which is done by Flight Analyst™ or the AAIMS module. It is done by the hardware manufacturer.

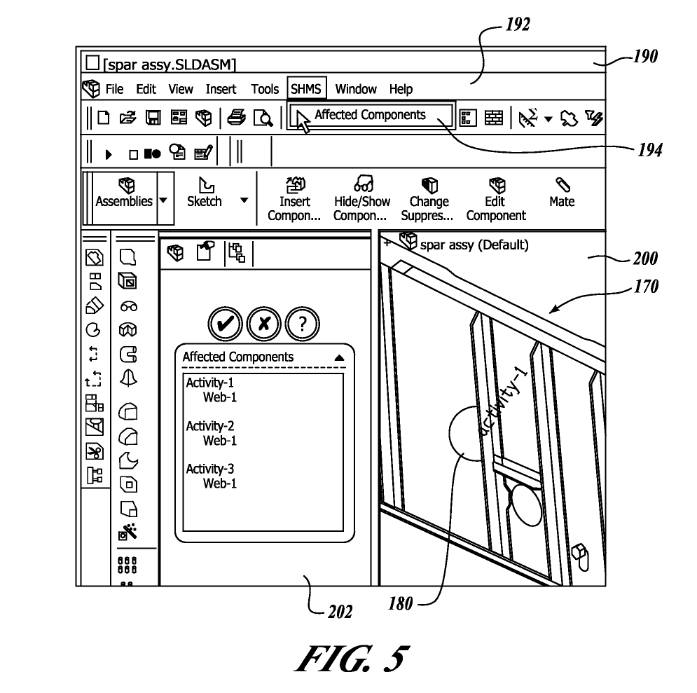

In FIG. 5, a partial screenshot of a graphical user interface window 190 is shown. The window 190 includes a menu bar 192, a 3D model display area 200, and an affected component display area 202. The menu bar 192 includes a pull-down menu that allows for user selection of an affected components function 194 that when selected by the user, presents the affected components display area 202. The affected components display area 202 identifies all affected aircraft components that come in contact with the displayed activity icons. In this embodiment, each of the activity icons 180, 182, and 184, as shown in FIG. 4, affect only a single component; web-1.

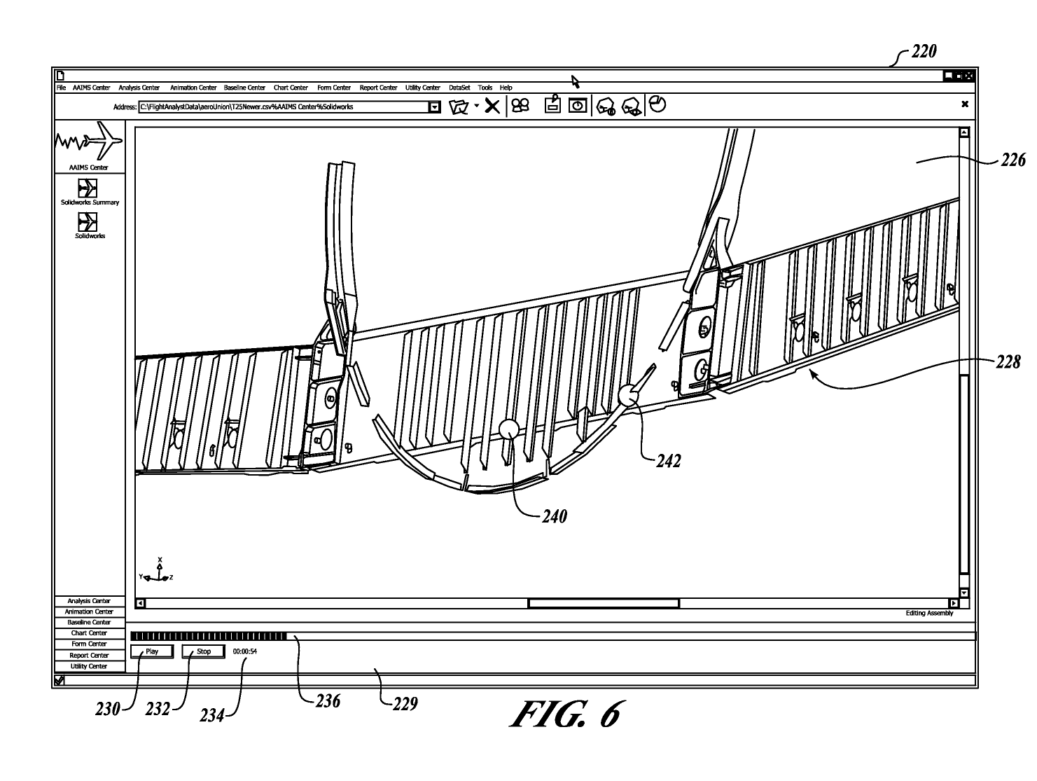

As shown in FIG. 6, a graphical user interface window 220 as generated by the processor 36 and displayed on the display 38 presents a partial view of a cross-section of an aircraft 3D model 228 in a display area 226. A video control section 229 is presented below the display area 226. The video control area 229 includes a play button 230, a stop button 232, a timer 234, and a time scale 236. The processor 36 generates and stores a video using the data received from the system 26. In this embodiment, the generated video includes some or all of the previously created 3D model, any sensed motion of the 3D model, or any events that are sensed relative to the 3D model. The activity icons that are presented on the solid model are associated not just with the location on the solid model, but also with a point in time or points in time during the operation of the aircraft. Thus, when a user selects the play button 230, the activity icons, such as icons 240 and 242, are presented in the model at the times in which they are identified by the associated sensors. This allows a user to compare the display of the activity icons 240 and 242 with other operational data. The timer 234 and time scale 236 indicate the point in time of the video presented in the display area 226.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An apparatus for presenting event activities associated with an operational system having one or more sensors, the apparatus comprising:
a display device; and
a processing device in data communication with the display device, the processing device comprising:
an event detection component configured to detect one or more events that exceed at least one predefined threshold limit based on data produced by the one or more sensors;
a location component configured to determine the location of the detected one or more events; and
a presentation component configured to present a 3-dimensional model of at least a portion of the system and one or more activity icons on the display device based on the identified location, wherein each activity icon is associated with a detected event, the 3-dimensional model includes features that are associated with actual parts of the operational system.

2. The apparatus of claim 1, wherein the event detection component is further configured to detect intensity of the detected one or more events and the presentation component is further configured to present each of the activity icons in one of a plurality of colors based on the associated detected intensity.

3. The apparatus of claim 1, wherein the event detection component is further configured to detect intensity of the detected one or more events and the presentation component is further configured to present each of the activity icons in one of a plurality of shapes based on the associated detected intensity.

4. The apparatus of claim 1, wherein the event detection component is further configured to detect intensity of the detected one or more events and the presentation component is further configured to present each of the activity icons in one of a plurality of sizes based on the associated detected intensity.

5. The apparatus of claim 1, wherein the event detection component is further configured to identify a time of occurrence for the one or more detected events and the presentation component is further configured to generate a video image of at least a portion of the system and present the one or more detected events based on the identified time of occurrence.

6. The apparatus of claim 1, further comprising:
an affected parts component configured to determine parts of the system that are affected by the detected one or more events and present a list of at least a portion of the affected parts.

7. The apparatus of claim 6, wherein the affected parts component determines what actual parts are affected if associated features of the 3-dimensional model intersect with at least one of the presented activity icons.

8. The apparatus of claim 1, wherein the operational system is a vehicle.

9. The apparatus of claim 1, wherein the operational system includes manufacturing machinery.

10. A method for presenting event activities associated with an operational system having one or more sensors, the method comprising:
detecting one or more events that exceed at least one predefined threshold limit based on data produced by the one or more sensors;
determining the location of the detected one or more events; and
displaying a 3-dimensional model of at least a portion of the system and one or more activity icons on a display device based on the identified location, wherein each activity icon is associated with a detected event, the 3-dimensional model includes features that are associated with actual parts of the operational system.

11. The method of claim 10, further comprising:
detecting intensity of the detected one or more events,
wherein displaying intensity includes displaying each of the activity icons in one of a plurality of colors based on the associated detected intensity.

12. The method of claim 10, further comprising:
detecting intensity of the detected one or more events,
wherein displaying intensity includes displaying each of the activity icons in one of a plurality of shapes based on the associated detected intensity.

13. The method of claim 10, further comprising:
detecting intensity of the detected one or more events,
wherein displaying intensity includes displaying each of the activity icons in one of a plurality of sizes based on the associated detected intensity.

14. The method of claim 10, further comprising:
identifying a time of occurrence for the one or more detected events; and
generating a video image of at least a portion of the system, the video image presents the one or more detected events based on the identified time of occurrence.

15. The method of claim 10, further comprising:
determining parts of the system that are affected by the detected one or more events; and
presenting a list of at least a portion of the affected parts.

16. The method of claim 15, wherein determining affected parts determines what actual parts are affected if associated features of the 3-dimensional model intersect with at least one of the presented activity icons.

17. The method of claim 10, wherein the operational system is a vehicle.

18. The method of claim 10, wherein the operational system includes manufacturing machinery.
